(19) United States
(12) Patent Application Publication
(10) Pub. No.: US 2018/0374324 A1
(43) Pub. Date: Dec. 27, 2018

(54) Capacitive Tamper Detection System For Smart Safe or Automated Teller Machine

(71) Applicant: Catamoeda Pesquisa e Desenvolvimento de Máquinas S.A., Sáo Jose (BR)

(72) Inventors: Deivid Henrique Coutinho, Florianópolis (BR); Vilmar Claudino Dos Santos Filho, Florianópolis (BR); Victor Pagliari Levy, Florianópolis (BR)

(21) Appl. No.: 16/063,000

(22) PCT Filed: Oct. 20, 2016
(86) PCT No.: PCT/US2016/057878

§ 371 Date: Jun. 15, 2018

(30) Foreign Application Priority Data
Dec. 16, 2015 (BR) 20 2015 031 520 7

(51) Int. Cl. G08B 13/12; G08B 13/26; G08B 13/08; E05G 1/10

(52) U.S. Cl. CPC G08B 13/126; E05G 1/10; G08B 13/08; G08B 13/26

(57) ABSTRACT

A capacitive tamper detection system for safes, ATMs and cash storage devices deters theft and vandalism without damaging the safe or the currency contained within the safe. One or more sensor plates are mounted to the interior walls and/or door of the safe. The sensor plates are separated from the walls and/or door of the safe by a dielectric to form, along with the walls or door of the safe, one or more capacitors. The capacitors formed by the sensor plates and the walls and/or door of the safe are part of an RC circuit having a time constant that depends on the capacitance. The time constant of the RC circuit causes an astable multivibrator to oscillate at a particular frequency, outputting a frequency signal. Changes in the capacitance caused by damage to the walls and/or door of the safe changes the time constant of the RC circuit, which in turn changes the frequency signal. A control circuit monitors the frequency signal and initiates an alarm or other action when the variation on the frequency signal exceeds a threshold. The frequency signal may be easily monitored by converting the frequency signal to a voltage value.

### RELATED APPLICATIONS

This application claims priority to Brazilian patent Application Serial Number BR 20 2015 031520 7 filed 16 Dec. 2015, the entire contents of which are incorporated herein by reference.

### TECHNICAL FIELD

The present invention relates generally to smart safes and automated tellers machines (ATMs) and other cash storage devices and, more particularly, to a capacitive tamper detection systems for smart safes, ATMs, and similar devices to deter theft and vandalism.

### BACKGROUND

The use of automated teller machines for carrying out banking transactions is a convenience for consumers. ATMs are typically located in imperfect spaces, such as shopping centers, gas stations, supermarket chains, and convenience stores. Often times, the ATMs are located in places with a low level of security where there is increased probability of vandalism and/or theft. Safes and other cash storage devices are also subject to theft.

Various solutions exist in the prior art to prevent the theft or vandalism of smart safes and ATMs. One solution found in the prior art is to insert a vial that is pre-filled with ink into the interior of the cash box within the smart safe or ATM. If the smart safe or ATM is jarred suddenly, such as by an explosion, the vial will be broken, thus staining the bills and rendering them useless. In order for this technique to be effective, the vial must be fragile enough so that it breaks from a sudden shock. One problem with this approach is that the accidental dropping of the safe during handling may cause the vial to break. Thus, there is a risk that the currency will be unusable and that the operator of the ATM will incur losses.

Another system used to deter theft employs a mixture of metallic elements that undergo and an aluminothermic reaction, or more precisely a thermos reaction, when tampering is detected. Once the reaction is initiated, heat is produced and burns the currency within the smart safe or ATM. This solution is also subject to false triggering, especially during transportation of the smart safe or ATM, such that there is a risk of injury to people near the smart safe or ATM, not to mention losses for the operator when the currency is destroyed.

The aforementioned solutions, in addition to the problem of false triggering, may cause damage to the ATM when activated. Because the cost of smart safe or ATMs is high, especially the mechanisms for transporting and counting money, the replacement of these machines represents a significant cost to the operator.

Accordingly, there is a need for improved tamper detection systems for cash storage devices, such as safes and ATMs that will deter theft and vandalism without destroying or rendering currency contained therein useless, and without damaging the smart safe or ATM. Also, there is a need for tamper detection systems for smart safe or ATMs that is suitable for use of smart safe or ATMs already in service that lack security.

### SUMMARY

The present invention relates to a capacitive tamper detection system for safes, ATMs, and similar devices for storing currency that can deter theft and vandalism without damaging the safe or the currency contained within the safe. One or more sensor plates are mounted to the interior walls and/or door of the safe. The sensor plates are separated from the walls and/or door of the safe by a dielectric to form, along with the walls or door of the safe, one or more capacitors. The capacitors formed by the sensor plates and the walls and/or door of the safe are part of an RC circuit having a time constant that depends on the capacitance. The time constant of the RC circuit causes an astable multivibrator to oscillate at a particular frequency, outputting a frequency signal. Changes in the capacitance caused by damage to the walls and/or door of the safe changes the time constant of the RC circuit, which in turn changes the frequency signal. A control circuit monitors the frequency signal and initiates an alarm or other action when the variation on the frequency signal exceeds a threshold. The frequency signal may be easily monitored by converting the frequency signal to a voltage value.

### BRIEF DESCRIPTION OF THE DRAWINGS

FIG. 1 is an exploded perspective view of an ATM and sensor plates.

FIG. 2 is a perspective view of the ATM with the sensor plates installed.

FIG. 3 illustrates an exemplary sensor plate.

FIG. 4 is a product diagram of the tamper detection system for the ATM.

FIG. 5 is a detailed schematic of the tamper detection system for the ATM.

### DETAILED DESCRIPTION

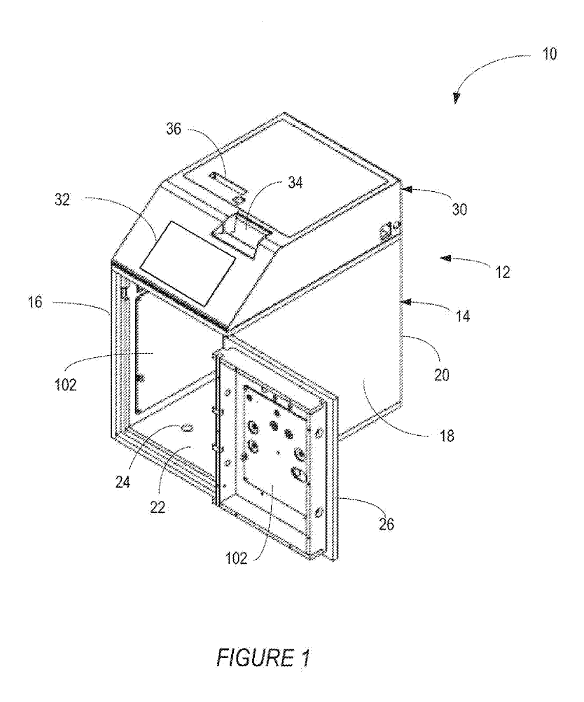

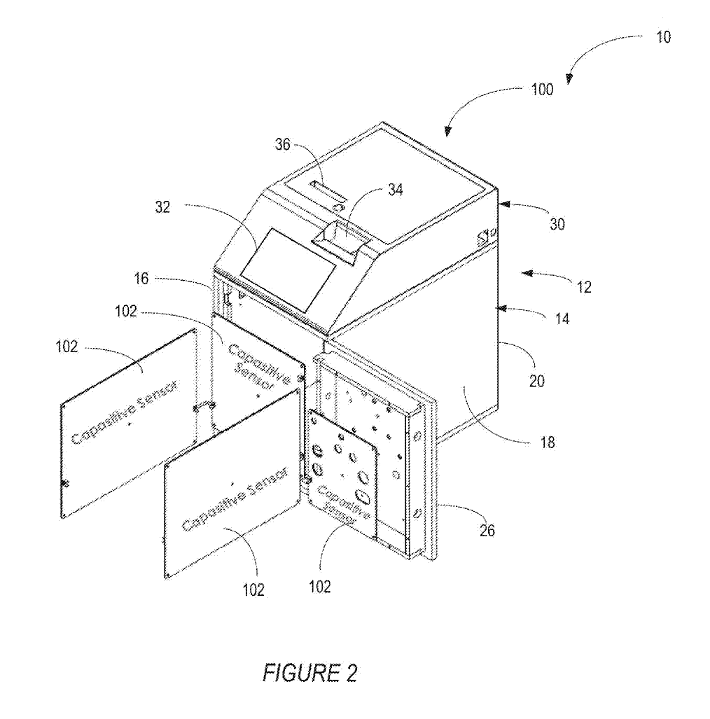

Referring now to the drawings, FIGS. 1 and 2 illustrate an exemplary electronic safe 10 that is equipped with a capacitive tamper detection system 100 as hereinafter described. The safe 10 comprises a base unit 14 and a top unit 30. The base unit 14 comprises a generally rectangular housing that contains a cash box or cassette where currency is stored. The safe 10 base unit 14 comprises side walls 16, 18, a back wall 20, and a bottom 22. A series of openings 24 are formed in the bottom 22 of the base unit 14 for anchoring the safe 10 to the floor or other support surface. A door 26 is connected to sidewall 18 by hinges (not shown) to provide access to the interior of the safe 10. The door 26 includes a locking mechanism to prevent unauthorized access to the interior of the safe 10. The top unit 30 includes a touch screen display 32 providing a user interface, and currency handling unit 34 for receiving currency. The top unit 30 may include one or more slots 36 to allow manual deposits of checks, gift certificates, or similar items.

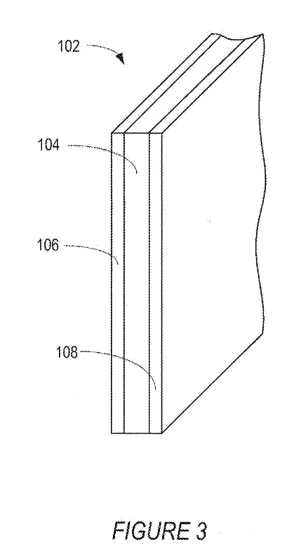

The safe 10 is equipped with a capacitive tamper detection system 100 (see FIG. 3) to deter vandalism and/or theft of the safe 10. A capacitor is an electronic component comprising two conductive plates separated by a dielectric. The plates of a capacitor store an electric charge. The ability to store, referred to as capacitance, is a function of the size, shape, material, and spacing of the plates. Damage to or deformation of the plates of the capacitor would cause the capacitance to change. This property of the capacitor is used in embodiments of the present invention to detect tampering with the safe 10.

Referring back to FIG. 2, sensor plates 102 are fixed to the walls 16, 18 and 20 of the safe, and/or to the door 26. The sensor plates 102 may be made from any electrically conductive material, such as a metallic plate, mesh, or fabric, or a conductive foam. The sensor plates 102 may be rigid or flexible. In the exemplary embodiment, the sensor plates 102 are made of a substrate such as printed circuit board (PCB) with a conductive layer disposed on one side thereof. A dielectric, such as polyacetal, separates the sensor plates 102 from the walls 16, 18, 20 and/or door 26 of the safe 10. FIG. 3 shows one embodiment of the sensor plate 102 comprising a PCB 104 having a metallic layer 106 on a first side of the PCB 104 and a sheet 108 of insulating material, such as polyacetal, applied to a second side of the PCB 104. The sensor plates 102 form, along with the walls 16, 18, 20 and/or door 26 of the safe, one or more capacitors. The sensor plates 102 function as one plate of a capacitor and the walls 16, 18, and 20 and/or door 26 of the safe function as the other plate of the respective capacitor.

In exemplary embodiments of the invention, the capacitors formed by the sensor plates 102 are part of a Resistor Capacitor (RC) circuit 110 (FIG. 3) having a time constant that depends on the R and C values. An astable multivibrator circuit, to which the RC circuit 110 is connected, generates a frequency signal F_{IN}. Changes in the capacitance caused by denting, perforating, or otherwise deforming of the walls 16, 18, 20 or doors 24 of the safe 100 will change the capacitance of the RC circuit 110, causing an abrupt change in the frequency of the frequency signal F_{IN}. Thus, tampering can be detected by monitoring the frequency signal F_{IN} for sufficiently large changes.

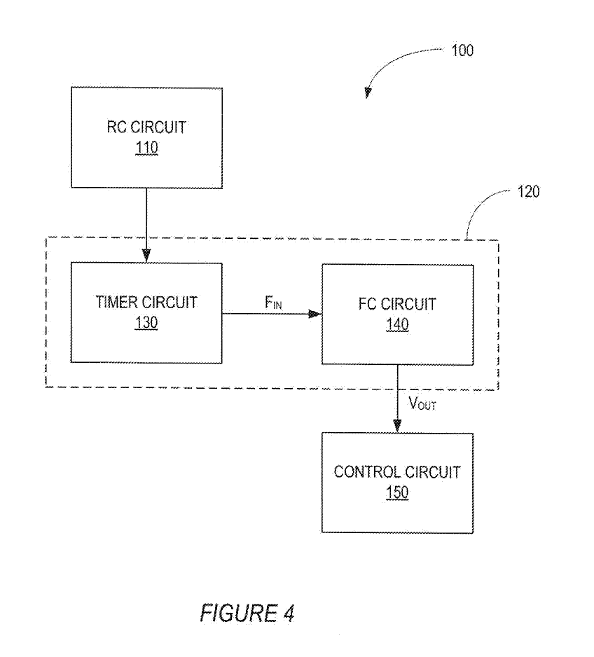

FIG. 4 is a block diagram illustrating the tamper detection system 100 according to one exemplary embodiment. The tamper detection system 100 comprises the RC circuit 110, a detector circuit 120, and a control circuit 150. The RC circuit 110 comprises one or more capacitors that include the sensor plates 102 and one or more resistors connected in series between a voltage source and ground. The RC circuit 110 has a time constant which is a function of the series capacitance of the RC circuit 110. If the walls 16, 18, and 20 or door 26 of the safe 10 are dented or perforated, the series capacitance of the RC circuit 110 will change, which in turn will cause the RC time constant to change.

A detector circuit 120 comprises a timer circuit 130 and a frequency converter circuit 140. The timer circuit 130 is configured as an astable multivibrator, which generates a square wave having a frequency that varies as a function of the RC time constant of the RC circuit 110. The square wave signal output from the timer circuit 130 serves as the frequency signal, F_{IN}. The frequency signal F_{IN} is input to the frequency converter circuit 140, which converts the frequency signal F_{IN} to an output voltage V_{OUT}. The output voltage V_{OUT} is input to a control circuit 150. The control circuit 150 may comprise a microprocessor, microcontroller, dedicated hardware circuit, firmware or a combination thereof. The control circuit 150 comprises logic for evaluating the output voltage V_{OUT} and initialing an action, such as triggering an alarm or sending notifications to specified persons. In one embodiment, the control circuit 150 includes circuitry that is configured to actuate external circuits such as sirens or actuators. In some embodiments, the control circuit 150 includes circuitry for automatically sending a notification message to designated persons or to a designated monitoring system that is configured to send notification messages and/or activate an alarm.

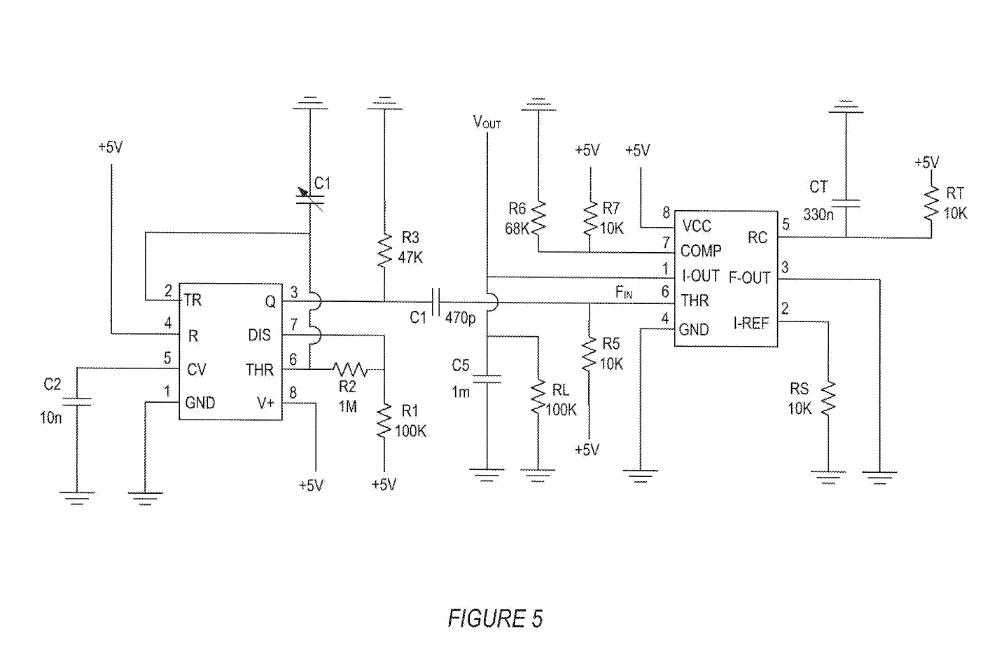

FIG. 5 is a detailed schematic of the RC circuit 110 and detector circuit 120 according to one embodiment. The RC circuit 110 comprises the series connected capacitors that include the sensor plates 102, denoted collectively by C1, as well as resistor R1 and resistor R2. The RC circuit 110 is connected to the timer circuit 130, which in this embodiment comprises an LM555N timer circuit from Texas Instruments. The “555 timer” is configured as an astable multivibrator. In this mode, the capacitor C1 charges through R1 and R2 and discharges through R2. The timer circuit 130 generates a square wave signal (i.e., the frequency signal F_{IN}) having a frequency that is a function of the capacitance of C1 and the ratio of the resistors R1 and R2. The frequency signal F_{IN} is given by:

$${F}_{IN} = \frac{1.44}{( R 1 + 2 R 2 ) * C 1} \qquad Eq . ( 1 )$$

where C1 is the series capacitance of the RC circuit 110, i.e., the capacitors formed by the sensor plates 102 and the walls 16, 18, 20 and/or door 26 of the safe 10.

The frequency signal F_{IN} is filtered, e.g., by a 470 pico farad capacitor C3, before being input to the frequency converter circuit 140. The frequency converter circuit 140 in this embodiment comprises an LM331AN voltage-to-frequency converter made by Texas Instruments, and configured to operate as a frequency-to-voltage converter. The frequency converter circuit 140 generates an output voltage V_{OUT} on pin 1 as a function of the input frequency signal F_{IN}. The output voltage V_{OUT} is given by:

V_{OUT}=F_{IN}×0.6967×(RL/RS)×(RT×CT) Eq. (2)

The tamper detection circuit 100 operates by detecting changes in the frequency of the frequency signal F_{IN} caused by changes in the series capacitance of the RC circuit 110. The denting, perforation or defamation of the walls of the safe 10 will cause changes in the capacitance of the RC circuit 110, which will be reflected by changes in the frequency of the input frequency signal F_{IN}. The frequency converter 140 converts the frequency signal F_{IN} to an output voltage V_{OUT} which is monitored by the control circuit 150. Thus, in the preferred embodiment, the control circuit 150 monitors the frequency signal indirectly by monitoring the output voltage.

The value of the frequency signal F_{IN}, when the safe 10 is undisturbed establishes a baseline frequency F_{B}. Damage to the walls 16, 18, 20, or door 26 of the safe 10 will cause the frequency signal F_{IN} to deviate from the baseline frequency F_{IN}. The control circuit 150 is configured to look for such abrupt changes in the frequency F_{IN} that are indicative of tampering. Small variations from the baseline frequency F_{B}, which may be caused by touching the safe 10 or by environmental factors, will not set off an alarm. Any change in F_{IN} will result in a corresponding change in V_{OUT}. The control circuit 150 is configured to set off an alarm or send a notification when the difference between the detected frequency F_{IN} and the baseline frequency F_{B} exceeds a predetermined amount, or equivalently, when the output voltage V_{OUT} exceeds a baseline output voltage by a predetermined amount.

The tamper detection system 100 provides a low cost system for reliability detecting tampering. The control circuit 150 can be programmed to reliably identify false alarms. The tamper detecting system 100 is also difficult to circumvent or defeat because the components are housed internally within the safe.

1-24. (canceled)

25. A tamper-detection system for a cash storage device, the tamper detection system comprising:
at least one capacitor formed by a wall or door of the cash storage device and a sensor plate separated from the wall or door by a dielectric, the sensor plate comprising a substrate with a conductive layer on one side thereof.
one or more resistors connected in series with the series capacitors to form a Resistor Capacitor (RC) circuit having an RC time constant dependent on the capacitance of the series capacitors;
a detector circuit connected to the RC circuit and configured to generate a frequency signal having a frequency dependent on the RC time constant; and
a control circuit configured to monitor the frequency signal and to detect tampering of the walls or door of the cash storage device based on changes in the frequency signal.

26. The tamper detection system according to claim 25 comprising two or more capacitors connected in series.

27. The tamper detection system according to claim 25 wherein the conductive layer comprises a metallic mesh.

28. The tamper detection system according to claim 25 comprising a least two sensor plates mounted to respective walls of the cash storage device and forming two series connected capacitors in the RC circuit.

29. The tamper detection system according to claim 25 wherein the detector circuit comprises a timer circuit connected to the RC circuit and configured to generate the frequency signal.

30. The tamper detection system according to claim 29 wherein the timer circuit and the RC circuit are configured to operate as an astable multivibrator.

31. The tamper detection system according to claim 25 wherein the detector circuit comprises a frequency converter circuit configured to convert the frequency signal to an output voltage suitable for processing by the control circuit.

32. The tamper detection system according to claim 31 wherein the control circuit is configured to detect tampering by comparing a change in the output voltage to a threshold.

33. A cash storage device having a tamper detection system, the cash storage device comprising:
a housing including a plurality of walls;
at least one capacitor formed by a wall or door of the cash storage device and a sensor plate separated from the wall or door by a dielectric, the sensor plate comprising a printed circuit board with a metallic layer on one side thereof;
one or more resistors connected in series with the series capacitors to form a Resistor Capacitor (RC) circuit having an RC time constant dependent on the capacitance of the series capacitors;
a detector circuit connected to the RC circuit and configured to generate a frequency signal having a frequency dependent on the RC time constant; and
a control circuit configured to monitor the frequency signal and to detect tampering of the walls or door of the cash storage device based on changes in the frequency signal.

34. The cash storage device according to claim 33 comprising two or more capacitors connected in series.

35. The cash storage device according to claim 33 wherein the metallic layer comprises a metallic mesh.

36. The cash storage device according to claim 33 comprising a least two sensor plates mounted to respective walls of the cash storage device and forming two series connected capacitors in the RC circuit.

37. The cash storage device according to claim 33 wherein the detector circuit comprises a timer circuit connected to the RC circuit and configured to generate the frequency signal.

38. The cash storage device according to claim 37 wherein the timer circuit and the RC circuit are configured to operate as an astable multivibrator.

39. The cash storage device according to claim 33 wherein the detector circuit comprises a frequency converter circuit configured to convert the frequency signal to a voltage signal suitable for processing by the control circuit.

40. The cash storage device according to claim 39 wherein the control circuit is configured to detect tampering by comparing a change in the output voltage to a threshold.

41. A method of detecting tampering with a cash storage device, the method comprising:
forming a capacitor by mounting a sensor plate to a wall of the cash storage device and separating the sensor plate from the wall of the cash storage device by a dielectric, the sensor plate comprising a conductive layer on one side thereof;
connecting the capacitor formed by the sensor plate and the wall of the cash storage device with one or more resistors to from a resistance-capacitance (RC) circuit, having an RC time constant dependent on the capacitance of the series capacitor;
generating an frequency signal t having a frequency dependent on the time constant of the RC circuit;
monitoring the frequency signal; and
detecting tampering based on changes in the frequency signal.

42. The method according to claim 41 comprising two or more capacitors connected in series.

43. The method according to claim 41 wherein the conductive layer comprises a metallic mesh.

44. The method according to claim 41 further comprising:
forming at least two capacitors by mounting two or more sensor plates to respective walls of the cash storage device and separating each the sensor plates from the walls of the cash storage device by a dielectric; and
connecting the two or more capacitors with one or more resistors to form the RC circuit.

45. The method according to claim 41 further comprising generating the frequency signal by a timer circuit connected to the RC circuit.

46. The method to claim 45 further comprising configuring the timer circuit and the RC circuit to operate as an astable multivibrator.

47. The method according to claim 41 further comprising converting the frequency signal to an output voltage suitable for processing by the control circuit.

48. The method according to claim 47 wherein detecting tampering based on changes in the frequency signal comprises comparing changes in the output voltage to a threshold.
